(19) United States
(12) Patent Application Publication
(10) Pub. No.: US 2003/0096602 A1
(43) Pub. Date: May 22, 2003

(54) Service provision

(76) Inventors: Lisa Hunt, Holmer Green Bucks (GB); Philip Woolff, Barnes London (GB)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/061,161

(22) Filed: Feb. 4, 2002

(30) Foreign Application Priority Data
Nov. 18, 2001 (GB) 0128472.8

(51) Int. Cl. H04M 3/42

(52) U.S. Cl. 455/414; 455/445

(57) ABSTRACT

A method and apparatus for providing a service in which a handheld personal communication device is used to make contact with a service centre providing a service in which information is transferred and tasks are performed on a user's behalf in response to specific requests. The service centre responds to calls made from handheld devices and perform tasks in response to specific requests from the user relating to both help with operation of the handheld device and advice in response to specific requests channelled through the handheld device unrelated to the operation of the handheld device itself.

The invention relates to a handheld communications device and services connected with such.

With lives becoming ever busier, there are requirements for increasingly personalised services.

In accordance with a first aspect of the present invention there is provided apparatus for providing a personal and technical support service comprising, a handheld personal communication device, a support desk for responding to calls from the handheld personal communication device, and a data source accessible to the support desk for providing information for both help with operation of the handheld device and advice in response to specific requests unrelated to the operation of the handheld device itself.

In accordance with a second aspect of the present invention there is provided a method for providing a service, the method comprising: providing a handheld personal communication device through which a user is able to make contact with a service centre providing a service in which information is transferred and tasks are performed on a user's behalf in response to specific requests; responding to calls made to the service centre to provide information and perform tasks in response to specific requests from the user relating to both help with operation of the handheld device and advice in response to specific requests unrelated to the operation of the handheld device itself.

The advantage of the present invention is that the service not only provides useful information for the user but also provides technical support for the handheld device arranged to allow access to the service. Not only is the service provided but also the person's access to the service is preserved through the technical support.

Requests to the service centre may be channelled through the handset. The service is preferably contacted via the communication device which may include a dedicated key programmed with a contact number for the service centre. This allows access to the service to be personal to the user and able to be made at any time. The connection between the user, the handset and the services provided for both the personal requirements of the user and the technical support of the handset, intertwines or interconnects the communication device, the user and the service to the greatest benefit of the user of the services.

Embodiments of the invention provide both technical support related to the communication device itself for both software and hardware as well as personal support for the user. Help will be provided to allow the user to get the most from operation of the phone, as well as with maintaining the operation of the phone to always allow access to the service centre. The technical support may include support for user operation of the device, receiving enhancements of both hardware and software, and in the choice of network contract.

The apparatus may comprise a plurality of handheld personal communication devices and the support desk comprises a plurality of support desks, the handheld devices may have respective dedicated keys programmed to contact respective ones of the support desks. The support desks may provide respective modes of interaction for information transfer with incoming callers, the dedicated keys of the handheld devices having associated data indicative of one of the respective modes of interaction, the data being utilised in routing the call to the one of the support desks providing the selected mode of interaction. The plurality of modes of interaction may include amongst other things the mode of operation of the destination communication equipment. The selected mode of interaction may be predefined by the user of the handheld device and may be defined at purchase of the handheld device.

The associated data may comprise routing information which may be a specific destination telephone number which can be programmed to be dialled when the dedicated key is actuated. The route may also comprise a specific destination switch.

The data source accessible to the support desk may be a plurality of data sources one of which could be a computer database which may be exclusive to the service centre. Other sources of data could be accessed via the internet.

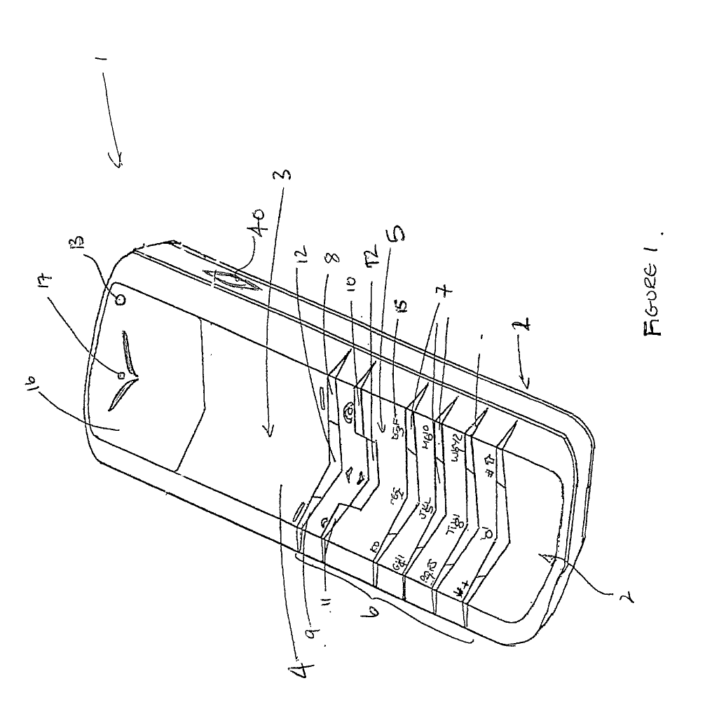

The invention will now be described in greater detail with reference to FIGS. 1 to 4 of the accompanying drawings of which:

FIG. 1 is a perspective view of a communication device showing one embodiment of the invention;

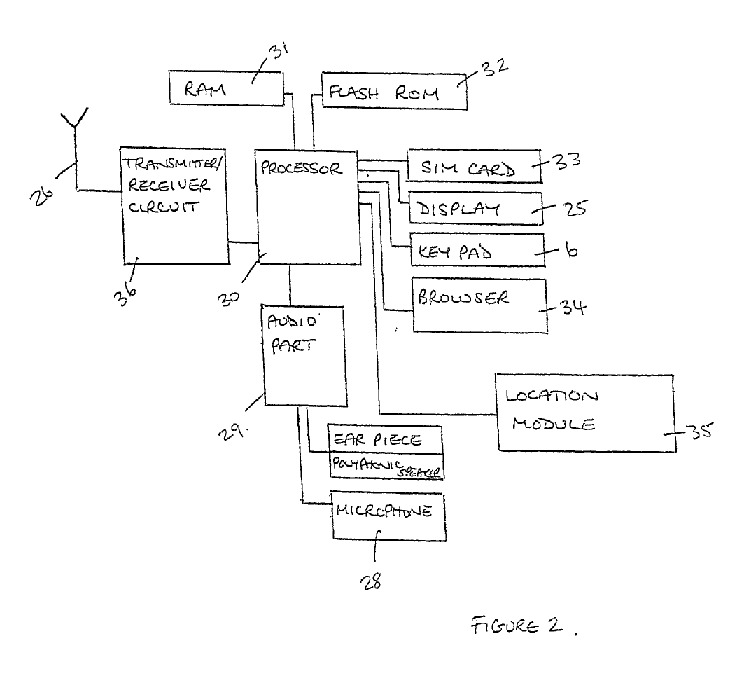

FIG. 2 is a schematic representation of a communication device suitable for embodiments of the present invention;

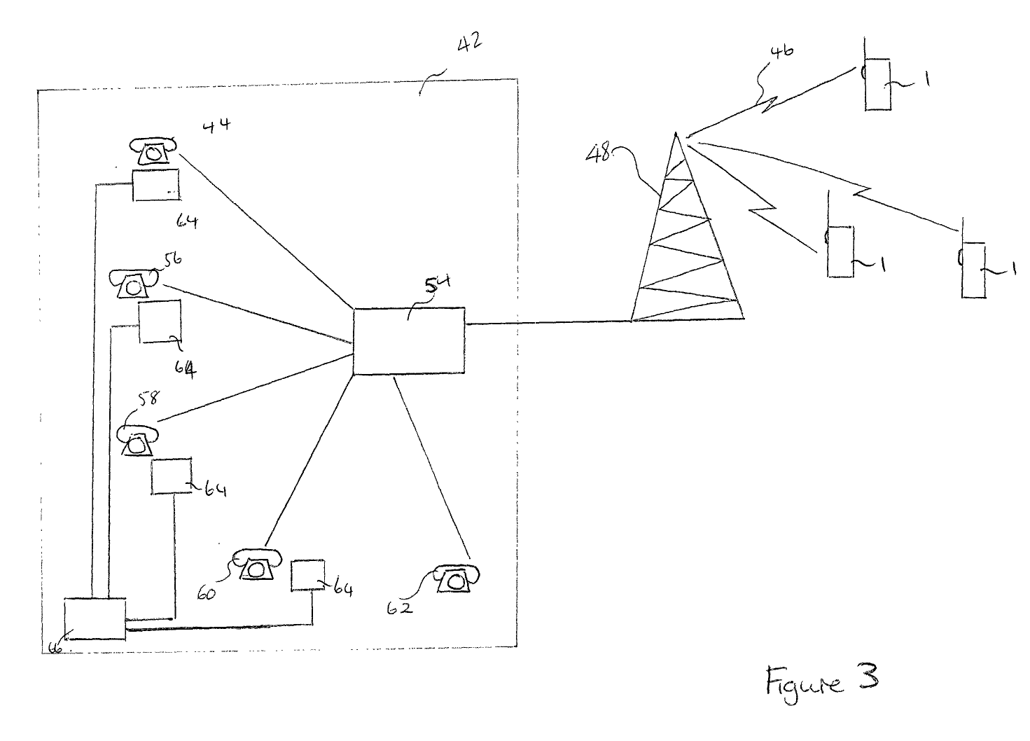

FIG. 3 is a schematic representation of a network for routing calls to a service centre in accordance with embodiments of this invention; and

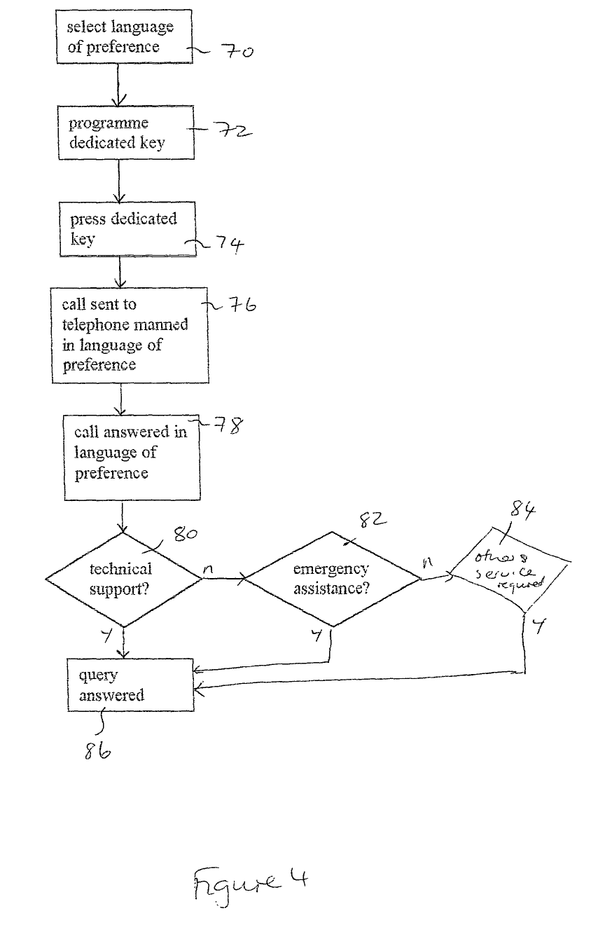

FIG. 4 is flow chart showing initial set up and future operation of an embodiment of the invention.

A device of an embodiment of the present invention illustrated in FIG. 1 is a communication device 1 with a casing 2. The casing 2 has a front face 3 providing a display region 4 and an input region 5 that includes a key array 6. The key array 6 includes a first group of alphanumeric keys 7, for entering telephone numbers, writing text messages (SMS), writing names (associated with phone numbers), etc. Each of the twelve alphanumeric keys 7 is provided with a figure “0-9” or a sign “#” or “*”, respectively. In an alpha mode each key is associated with a number of letters and special signs used in text editing. The key array 6 additionally comprises two soft keys 8, 9, two call handling keys 10, 11, two scroll keys 12, and an on/off key 13.

The functionality of the soft keys 8, 9 may depend on the state of the communication device and position within the menu accessed using the scroll keys 12. The current functionality of the soft keys 8, 9 can be shown in separate fields in the display region 4 just above the respective keys 8, 9.

The two call handling keys 10, 11 are used for establishing a call 10 or a conference call, terminating a call 11 or rejecting an incoming call.

The two direction keys or scroll keys 12, in the handset illustrated are placed centrally on the front surface of the communication device between the display region 4 and the group of alphanumeric keys 7 perform a scrolling function.

This seamless face 3 is formed from a light guide providing light to illuminate the display region 4 and key legends 15 located on the seamless face 3and associated with individual keys of the key array 6.

The front face 3 is overlaid with a pillow 16 providing apertures 17 to channel sound from a loud speaker and providing an appropriate feel for an element of the device that will be located close to the user's ear. The front face 3 is surrounded by a bezel 19 that can be made from a precious metal. This acts to protect the edges of the face 3 and can help in some embodiments in securing the elements of the casing 2 together.

The keys of the key array in this particular embodiment are arranged to provide particular sensory guidance to the user. Aspects of the design also allow the seamless face 3 to be made from a wide range of materials including those that are brittle and so need to be carefully handled and protected from shattering.

The casing 2 is formed from the front face 3 surrounded by the bezel 19, a side frame 20 and a back cover. The interface between the side frame 20 and the bezel 19 and the side frame 20 and the rear cover are shielded by rails 22, 23 in this embodiment. The construction of the casing 2 enables the casing 2 to be opened with ease to update the engine inside when desired.

The radio telephone 1 incorporates a dedicated key 40 that dials a programmed number automatically when pressed. In embodiments of the invention this will be accomplished either with or without the need to press the ‘call’ key 10 subsequently. The key can be provided with a key guard to avoid inadvertently calling the service centre 42. The number associated with dedicated key 40 will dial a service centre that provides a number of services. In one embodiment of the invention the services include, technical support for the radio telephone, personal support allowing the owner of the telephone to gather information and tap in to exclusive services, and emergency assistance for the owner e.g. for medical help or roadside assistance. Other services could, however, be provided.

The device will now be briefly discussed with reference to its functional elements. The radio telephone 1, includes the key array 6, a display 25, an antenna 26, an ear piece speaker 18, a polyphonic speaker 27, and a microphone 28. The communication device 1 is adapted for communication via a wireless telecommunication network, e.g. a wireless network. However, the communication device could also have been designed for a cordless network. FIG. 2 shows schematically and functionally elements of the communication device 1. The microphone 28 records the user's speech, and the analogue signals formed thereby are A/D converted by an A/D converter before the speech is encoded in an audio part 29. The encoded speech signal is transferred to processor 30. The processor 30 may support software in the phone. The processor 30 also forms the interface to peripheral units of the apparatus. These may include a Random Access Memory (RAM) 31 and a Flash Read Only Memory (ROM) 32, a SIM card 33, the display 25, and the key array 6, and perhaps a browser application 34, and a location module 35. The browser application 34 can be used to request and receive information from the Internet. The location module 35 enables the terminal 1 to determine its current position.

The processor 30 communicates with a transceiver 36, e.g. a circuit, which is adapted to send and receive messages in a telecommunication network. The telecommunications network may be a GSM network, but the invention may also be applied in connection with other networks, such as other kinds of wireless networks and various forms of cordless phone systems or in dual band phones accessing sets of these systems/networks. The audio part 29 speech-decodes the signal, which is transferred from the processor 30 to the earpiece 18 via a D/A converter.

The radio telephone incorporating a dedicated key 40 for calling the service centre in accordance with this embodiment of the invention allows simple access to the services provided. In this embodiment the number associated with the dedicated key contains routing information sufficient to indicate that the call should be answered in a specific language, although other modes of interaction as discussed previously and others that will be apparent to the skilled man could be used instead, or in addition. In this embodiment the mode of interaction e.g. the language for answering the call is specified initially at the time of purchase of the radio telephone. This can be reprogrammed at a future date if the preference changes. This will be more likely for some preferences than for others e.g. language. It may also need to be changed if the service provider changes number or dialling code.

The selected mode of interaction, i.e. in this embodiment language, is associated with the routing information for connecting the radio telephone 1 to the service centre 42 provided by the dedicated key 40. For example, a specific phone 44 always manned in Arabic will ring in response to the button being pressed. This could be the result of an over-the-air channel connection 46 to the mobile network 48, and a connection 50 from the network 52 to the switch board 54 of the service provision centre 42. The particular number dialled ensures the call is switched to the appropriate telephone 44 or desk out of those available, 44, 56, 58, 60, 62.

As mentioned earlier, in the current embodiment, the mode of interaction is the language in which the call is answered but it could provide for other preferences such as the gender of the person answering, or could extend to a personal preference for say an automated response. In each of the instances the service itself or the information provided will not differ with the information preferences expressed in the concierge key. Two people calling the service centre on different handheld devices one having a preference, say, for talking to a woman, and the other for talking to a man will each be provided with exactly the same range of options. It is just the manner of delivery of the options that will differ.

With caller identification available the caller will be able to be identified so a personal greeting can be made on answering the call. Over a period of time user preferences associated with a particular caller will be built up and tailored suggestions and information provided. This does not change the services provided merely streamlining the delivery of useful information to the respective callers.

Caller identification can be sent when a number is dialled and could be used as an alternative to the dialled number to route the call to a destination operating in the user selected information transfer mode.

Turning now to FIG. 4, at the time of purchase in this embodiment of the invention the purchaser is asked for details of the language 70 that the concierge service should use when answering a query. The phone 1 is personalised by programming a particular telephone number to be dialled 72 when the dedicated key is pressed. The number is associated with the language that is to be used when responding to the call is the one selected e.g. Arabic, German, French. On pressing the key 74 the call will be routed 76 to a particular telephone that is always manned by an operator employed to speak in the selected language. Alternatively the programmed number may be for a phone with an automated message in the selected language. In alternative embodiments the call could be routed to a switch that is configured to send the call to an appropriate telephone currently manned by someone answering the phone in the particular language. Either of these mechanisms allows the service provider to be able to ensure that the call will be answered by a person speaking the language specified.

Once the phone has been answered 78, a range of services are available for the user. The call may be for emergency assistant 80, technical support for the telephone 82 or for a range of information and leisure support 84. The services include, technical support, personal support, and emergency assistance. For each query will be answered 86 by an operator speaking in the language of preference. The services are linked to the owner of the device, and the device itself. In this way the service not only provides information useful to the owner of the device but is also supports the continued ability of the owner to access the information through technical support of the device. This may be information on how to operate the device, enter into additional operating contracts, obtain new features or software upgrades, or troubleshooting and help with repair should that become necessary.

The concierge service accessed through the dedicated button 40 on a radio telephone that will direct calls to the service from any national or international location provides an exclusive service for people possessing the radio telephone 1 (the key to accessing the service). The service could, however, be contacted using another handset dialling the pre-programmed number. A specialist support team operating in a range of languages offered as reference provides information and help in accessing opera, art, travel, or food in addition to providing clear and concise product support for the handheld device primarily used for accessing the system and emergency assistance. The operators will be provided with data to allow all such queries to be answered. The data may be supplied in connection with computers 64 with access to an extensive database 66 which may be exclusively available to the service centre, and/or internet access, and or books or other sources of information. The operators may also be able to access information through additional phone calls. If a user's query cannot be answered with reference to data at the operators command, a team of researchers will work on providing an answer. These researchers will be adding to the data available in the data base to keep up with emerging trends and new requirements.

The concierge service provides information, recommendations, and even help with reservations at hotels, restaurants and theatres. It can locate specific products and services through a global network of contacts and can even offer exclusive client benefits and offers that may apply at particular key locations. The range of services and benefits offered can be augmented or otherwise altered to keep up with changing trends. All the information will be transferred to the user in the mode selected, e.g. in the appropriate language or by an operator of the requested gender. The information available will be independent of the route for calling the service centre, in particular the particular number dialled on pressing dedicated key, but the manner of delivery of the information will be dictated by the route, in this case determined by the number stored in association with the dedicated key.

Services that are provided may smooth the lot of the traveller by providing special offers and advice, such as automatic upgrades at specific hotels, and special rates exclusively for members. Help with holiday or business trip arrangements can be provided through partnerships with suitable travel specialists. In addition, the service will endeavour to locate tickets for exclusive events even if these are sold-out events, be they sporting or cultural. Entrance to other venues that often require private membership may also be secured.

The service will enable travellers to obtain access to popular events without booking years in advance which is not always possible or desirable for the business or spur of the moment traveller who is not aware from one week to another of his/her likely location.

Another wing of the service may secure restaurant reservations at short notice for popular restaurants. As well as providing advice on where to eat in an unfamiliar, or familiar for that matter, location.

The personalised answering mode of the concierge service can also deliver information about emergency assistance should medical, legal, or other services, be required especially whilst travelling.

With the concierge service both the information available through the service for enhancing the life of the user and the means by which the information is accessed (via the handset) is supported by the service centre.

The aspects of the invention have been discussed with reference to a radio telephone. It will be clear to the skilled man that these apply equally to other portable communications devices supporting other functions, such as electronic diaries, notepads amongst others.

The present invention includes any novel feature or combination of features disclosed herein either explicitly or any generalisation thereof irrespective of whether or not it relates to the claimed invention or mitigates any or all of the problems addressed.

In view of the foregoing description it will be evident to a person skilled in the art that various modifications may be made within the scope of the invention.

1. Apparatus for providing a personal and technical support service comprising
a handheld personal communication device
a support desk for responding to calls from the handheld personal communication device, and
a data source accessible to the support desk for providing information for both help with operation of the handheld device and advice in response to specific requests unrelated to the operation of the handheld device itself.

2. Apparatus according to claim 1 wherein the apparatus comprises a plurality of handheld personal communication devices and the support desk comprises a plurality of support desks, the handheld devices having respective dedicated keys programmed to contact respective ones of the support desks.

3. Apparatus according to claim 2 wherein the support desks provide respective modes of interaction for information transfer with incoming callers, the dedicated keys of the handheld devices having associated data indicative of one of the respective modes of interaction, the data being utilised in routing the call to the one of the support desks providing the selected mode of interaction.

4. Apparatus according to claim 3 wherein one of the plurality of modes of interaction comprises the mode of operation of the destination communication equipment.

5. Apparatus according to claim 3, wherein the associated data comprises routing information.

6. Apparatus according to claim 5, wherein the routing information comprises a specific destination telephone number.

7. Apparatus according to claim 6 wherein the dedicated key is programmed with the specific destination telephone number.

8. Apparatus according to claims 5, wherein the route comprises a specific destination switch.

9. Apparatus according to claim 3, wherein the selected mode of interaction is predefined by the user of the handheld device.

10. Apparatus according to claim 3, wherein the selected mode of interaction is defined at purchase of the handheld device.

11. Apparatus according to claim 3, wherein the mode of interaction comprises a language selected for information transfer.

12. Apparatus according to claim 1, wherein the data source is a plurality of data sources.

13. Apparatus according to claim 1, wherein the data source is a computer database.

14. Apparatus according to claim 13, wherein the computer database is accessed via the internet.

15. Apparatus according to claim 1, wherein the information includes information for help with emergency assistance.

16. Apparatus according to claim 1, wherein the information includes information for organisation of social activities.

17. Apparatus according to claim 1, wherein the information includes information for leisure support.

18. Apparatus according to claim 1, wherein the information includes information for roadside assistance.

19. Apparatus according to claim 1, wherein the service is contacted via a dedicated key on the handheld device.

20. A handheld personal communication device suitable for operation with the apparatus according to claim 1.

21. A service centre suitable for operation with the handheld device according to claim 20.

22. A method for providing a service, the method comprising:
providing a handheld personal communication device through which a user is able to make contact with a service centre providing a service in which information is transferred and tasks are performed on a user's behalf in response to specific requests;
responding to calls made to the service centre to provide information and perform tasks in response to specific requests from the user relating to both help with operation of the handheld device and advice in response to specific requests unrelated to the operation of the handheld device itself.

23. A method according to claim 22 wherein the service centre comprises a plurality of support desks, and wherein respective handheld personal communications devices are provided each having a dedicated key programmed to contact a respective one of the plurality of support desks.

24. A method according to claim 23 wherein the support desks provide respective modes of interaction for information transfer with incoming callers.

25. A method according to claim 24 wherein one of the plurality of modes of interaction comprises the mode of operation of the destination communication equipment.

26. A method according to claim 24, wherein the selected mode of interaction is predefined by the user of the handheld device.

27. A method according to claim 24, wherein the selected mode of interaction is defined at purchase of the handheld device.

28. A method according to claim 24, wherein the mode of interaction comprises a language selected for information transfer.

29. A method according to claim 22, wherein the information is sourced from a database.

30. A method according to claim 22, wherein the information includes information for help with emergency assistance.

31. A method according to claim 22, wherein the information includes information for organisation of social activities.

32. A method according to claim 22, wherein the information includes information for leisure support.

33. A method according to claim 22, wherein the information includes information for roadside assistance.

34. A method according to claim 22, wherein the service is contacted via a dedicated key on the handheld device.

35. A handheld personal communication device for contacting a service centre providing services in accordance with claim 22.

36. A method according to claim 22, wherein queries on matters relating to the personal communication device comprise operational queries.

37. A method according to claim 22, wherein the operational queries comprise technical support for operation of the handheld device.
